(19) United States
(12) Patent Application Publication
(10) Pub. No.: US 2008/0156825 A1
(43) Pub. Date: Jul. 3, 2008

(54) Apparatus For Filling Tubes With Piles Of Disc-Shaped Articles, Such As Pills

(75) Inventor: Giuseppe MONTI, Pianoro (Bologna) (IT)

Correspondence Address: WILLIAM J. SAPONE;COLEMAN SUDOL SAPONE P.C., 714 COLORADO AVENUE, BRIDGE PORT, CT, 06605, US

(73) Assignee: MARCHESINI GROUP S.P.A., Pianoro (Bologna) (IT)

(21) Appl. No.: 11/946,415

(22) Filed: Nov. 28, 2007

(30) Foreign Application Priority Data
Dec. 29, 2006 (IT) BO2006A 000899

(51) Int. Cl. B23Q 7/04

(52) U.S. Cl. 221/210

(57) ABSTRACT

An apparatus for filling tubes with piles of disc-shaped articles, such as pills, comprising: two functional elements (5h, 5j), hinged at a horizontal axis (K) and mobile between a loading region (C), in which the functional elements (5h, 5j) provide at least a corresponding seating (6) for receiving and retaining a relative pill (3) released by a plurality of supply units (1), and a disengagement region (D) of the pill (3), at which the functional elements (5h, 5j) are rotated by ninety degrees and cooperate with gripping organs (11); the gripping organs (11) being mobile in a vertical direction in order to gather the pill (3) borne by the functional elements (5h, 5j) into the relative disengagement region (D), and to release the pill (3) internally of a corresponding tube (10) in phase relation with the movement of the functional elements (5h, 5j).

### BACKGROUND OF THE INVENTION

The invention relates to the technical sector of machines for filling tubes, that is rigid cylindrical containers, with piles of disc-shaped articles, in particular pills.

The prior art describes a similar typology of machines comprising: a conveyor belt, which draws pills towards a loading station; a transporter organ, overlying the conveyor belt, which bears empty tubes oriented vertically and with an opening thereof arranged downwards, respectively through the loading station and towards a capping station; the loading station, which comprises two vertically-developing archimedes screws located near to one another arranged in proximity of opposite sides of the conveyor belt at a relative transversal loading section, being activated in counter-rotation to one another in order to intercept, on opposite sides thereof, the pills coming from the section, to raise the pills vertically and push them internally of a corresponding overlying tube, stationary and waiting; and the capping station, in which the capping of the tubes filled with a given number of pills is performed. The conveyor belt, the conveyor organ and the archimedes screws are activated in phase relation to one another, and intermittently, to enable insertion of the pills internally of each tube halted in turn at the loading station.

### SUMMARY OF THE INVENTION

In the light of the prior art, an aim of the present invention is to provide an apparatus for filling tubes with piles of disc-shaped articles, such as pills, which represents a new concept and also enables manipulation of fragile articles which have a tendency to crumble easily.

A further aim of the invention consists in providing an apparatus which satisfies the requisites of reliability, functionality and high productivity required in the sector under examination.

A further aim of the invention consists in making available an apparatus with relatively contained costs with respect to the advantages it provides.

The above aims are obtained by means of an apparatus for filling tubes with piles of disc-shaped articles, such as pills, which are released intermittently by at least a supply unit one after another, with a substantially vertical orientation, comprising: two functional elements which are hinged at a horizontal axis, which functional elements can be made to oscillate in phase relation with the release of the pills from the supply unit between a loading region, in which they are in proximity of the outlet section of the supply unit and in which each identifies at least a corresponding seating for receiving and retaining a relative pill released by the supply unit, and a disengagement region of the pill, in which the functional elements are rotated by a predetermined angle with respect to the horizontal hinge axis, enabling a gripping of the pill by gripping organs. The apparatus also comprises gripping organs, which are mobile according to a predetermined operating direction, which remove the pill borne by the functional elements into the relative disengagement region, and which release it internally of a corresponding tube in phase relation with the movement of the functional elements.

The apparatus in question advantageously satisfies the requisites of reliability, functionality and high productivity now required by the relevant sector; in particular, the apparatus enables manipulation of even fragile and easily crumbling articles, which are treated in the operating stages in such a way as not to compromise the integrity thereof.

### BRIEF DESCRIPTION OF THE DRAWINGS

The characteristics of the invention which have not become clear from the foregoing will more fully emerge in the following claims and with the 10 aid of the appended figures of the drawings, in which:

FIGS. 1, 3, 4, 5, 6 are corresponding schematic lateral views of the apparatus of the present invention, in five stages of an operating cycle;

FIG. 2 is a partial frontal view of the apparatus of the operating stage of FIG. 1, in which some parts have been removed better to evidence others.

### DESCRIPTION OF THE PREFERRED EMBODIMENTS

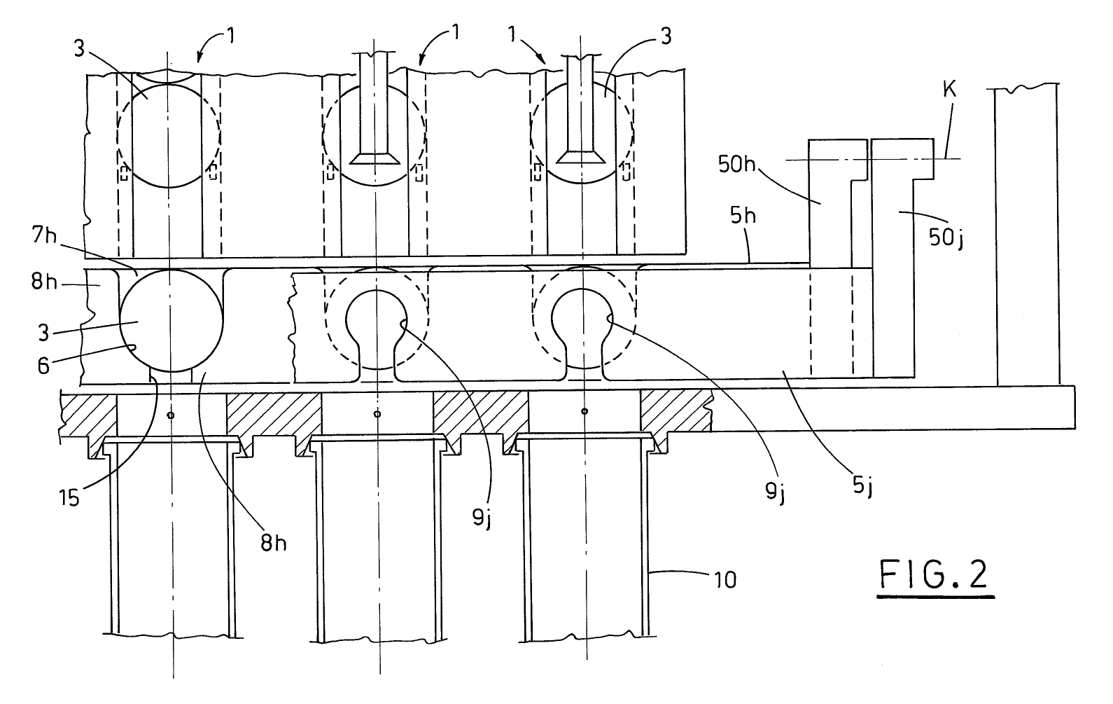

With reference to the accompanying figures of the drawings, 1 denotes a generalized supply unit of disc-shaped articles, such as pills, destined to release the articles from the relative outlet section SU one after another intermittently and with a substantially vertical orientation; the supply unit 1 belongs for example to a plurality of N supply units arranged side-by-side and preferably activated in synchrony (FIG. 2). The supply units 1 are, in the illustrated example, of known type and described in particular in Italian patent application BO2005A000657, belonging to the same applicant; each of these units 1 comprises: a vertical-axis channel 2 along which pills 3 (also oriented vertically) are supplied by force of gravity in a row; and a spoked element 4, interacting with the pills 3 supplied along the channel 2, step-activated to release therefrom one pill 3 at a time. In the example, the spoked element 4 exhibits an axis arranged perpendicularly with respect to the axis of the associated channel 2 and is provided with a plurality of radially-developing needle-shaped units 4h, each provided with a pair of distanced needles, which are in turn destined to exert a function of retaining a corresponding pill 3 and supporting overlying pills 3.

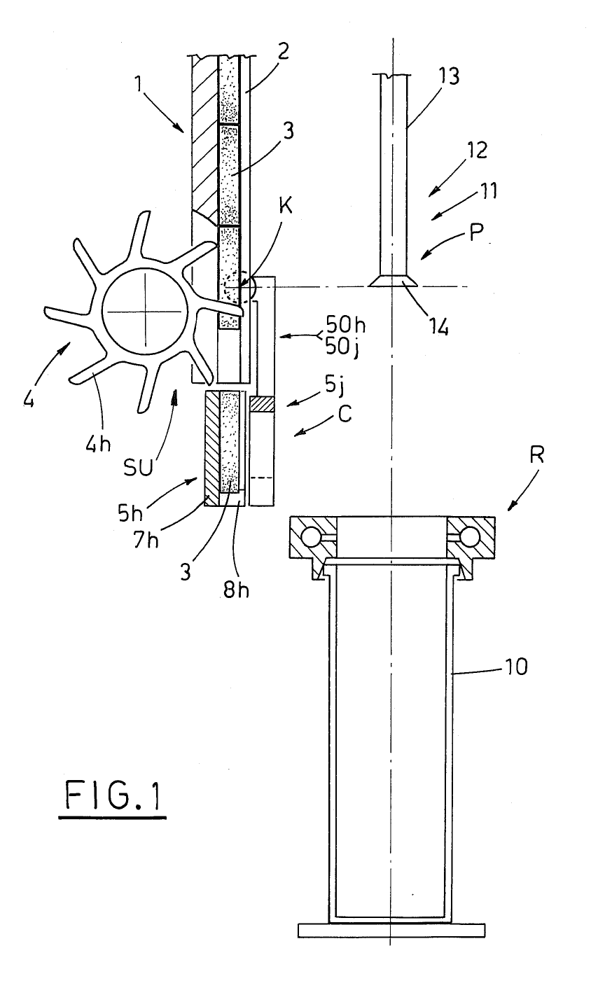

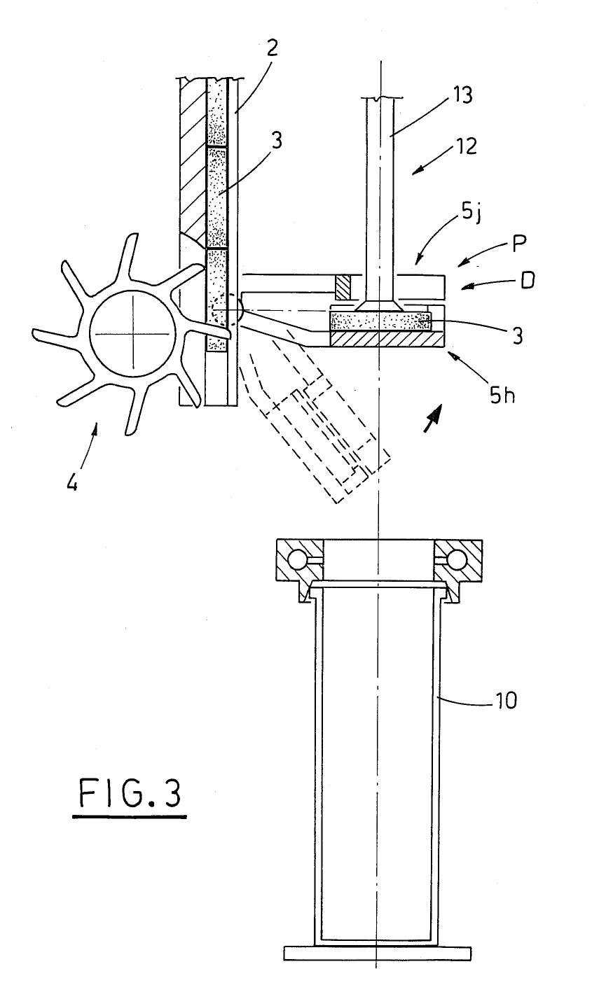

5h and 5j denote two functional elements, a first element and a second element, developing over all the lateral extension of the supply unit 1 (see FIG. 2) and connected at lateral ends thereof to respective operating arms 50h, 50j (FIG. 2 only illustrates the activating arms of a same end of the functional elements 5h, 5j) hinged at a common horizontal axis K and activated by actuator organs (not illustrated) which move the elements 5h, 5j between: a loading region C located at the outlet sections SU of the supply units 1, in which the elements 5h, 5j are arranged close to one another and oriented in a vertical direction, identifying seatings 6 for receiving and holding pills 3 in a position of stability, which pills 3 are released by the N number of supply units 1, as will be more fully explained herein below (FIGS. 1, 2, 6); and a disengagement region D (FIG. 3) in which the elements 5h, 5j are oriented for example in a horizontal direction, following rotation by 90° starting from the position assumed in the loading region C. In the disengagement region D the first element 5h is located at a lower height than the second element 5j.

In the illustrated example, with reference to FIGS. 1 and 2, in which the functional elements 5h, 5j are in the loading region C, the first element 5h is provided with a number of seatings 6 which is equal to the number of N outlet sections SU of the supply units 1, destined to receive corresponding pills 3 respectively released by the units 1. In particular, the seatings 6 are identified by a lateral wall 7h which constitutes a development surface of the first element 5h and by a plurality of shaped supports 8h fixed to the wall 7h and reciprocally intervalled, such that each seating 6 is identified by facing portions belonging to adjacent supports 8h and by the portion of wall 7h delimited by the supports 8h (FIG. 2); the pairs of facing portions are formed complementarily to the lower part of the pill 3 destined to be received in the seating 6 thus defined, thus advantageously guaranteeing stable retention in cooperation with the second element 5j, as will more clearly emerge herein below. The second element 5j affords lateral openings 9j, equal in number to the seatings 6, in the example of FIG. 2 each being constituted by a through-hole afforded perpendicularly to the development surface of the second element 5j and being laterally open towards the outside.

The elements 5h, 5j, arranged very closely to one another, exhibit the openings 9j of one superposed on the seatings 6 of the other, so that the pills housed therein are accessible from outside. The edges of the openings 9j also function as abutments for the pills 3, which are thus stably retained within the respective seatings 6 in the operating configurations, as will better emerge from the following description.

R denotes a station of known type for filling N tubes 10 at a time with piles of pills 3 released internally thereof by gripping organs 11 cooperating with the shaped elements 5h, 5j. The gripping organs 11, for example, are N aspirating units 12, each comprising a tubular element 13 terminating with a sucker 14 and functionally connected to a source in depression, not indicated in the figures; the aspiration units 12 are operated in a vertical direction in phase relation with the movement of the elements 5h, 5j, between a removal position P of the pills 3 borne by the elements 5h, 5j, and a release position PR of the pills internally of the corresponding tubes 10.

The apparatus for filling tubes of the present invention is now described, with reference to an operating cycle.

As has been mentioned, the supply units 1 operate in reciprocal synchrony, intermittently releasing pills 3 in phase relation with the activation of the elements 5h, 5j, of the aspiration units 12 and of the supply of tubes 10 into the filling station R.

With reference to FIGS. 1, 2, the shaped elements 5h, 5j are in the loading region C, close to one another and vertically-oriented, identifying the seatings 6 for receiving and stably retaining the pills 3 released by the overlying supply units 1; the pills 3 thus released insert in the corresponding seatings 6, maintaining the relative vertical orientation thereof thanks to the abutment action of the edges of the lateral openings 9j of the second element 5j.

The synchronized movement of the elements 5h, 5j follows, towards the disengagement area D, during which the elements 5h, 5j are rotated about the horizontal hinge axis K, maintaining the same reciprocal position of stable retention of the pills 3 in the respective seatings 6. In the example illustrated in the figures, the removal position P assumed by the aspiration units 12 is such that the second element 5j, on reaching the disengagement region D, inserts between the terminal portions of the units 12 at the position of the relative lateral openings 9j, until the suckers 14 are almost touching the corresponding pills 3 (FIG. 3). The shaped elements 5h, 5j end their run in the disengagement region D, assuming a horizontal position, as do the pills 3 they are transporting.

In phase relation with the arrival of the elements 5h, 5j in the disengagement region D, the units 12 are activated in aspiration in order to grip the pills 3 still retained by the elements 5h, 5j.

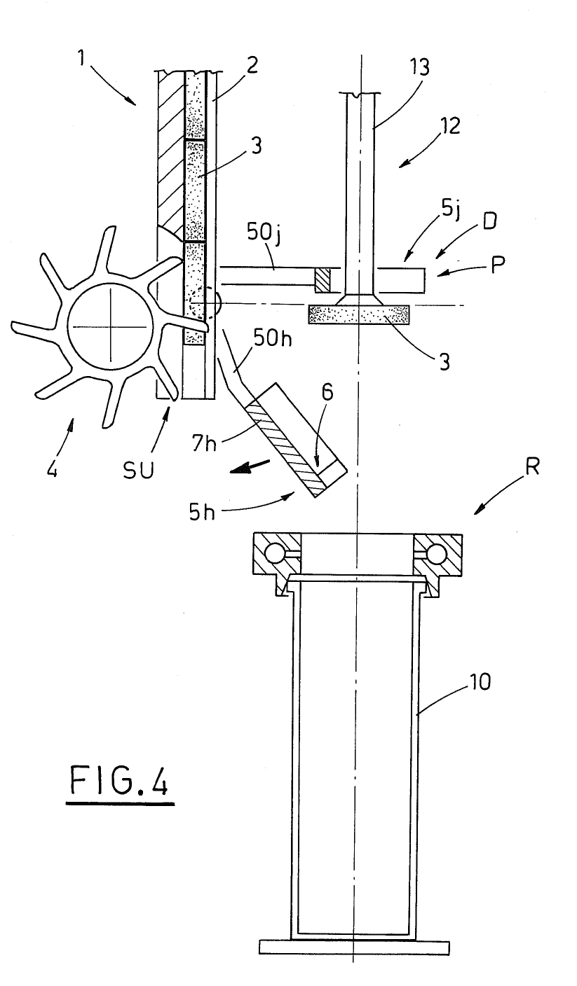

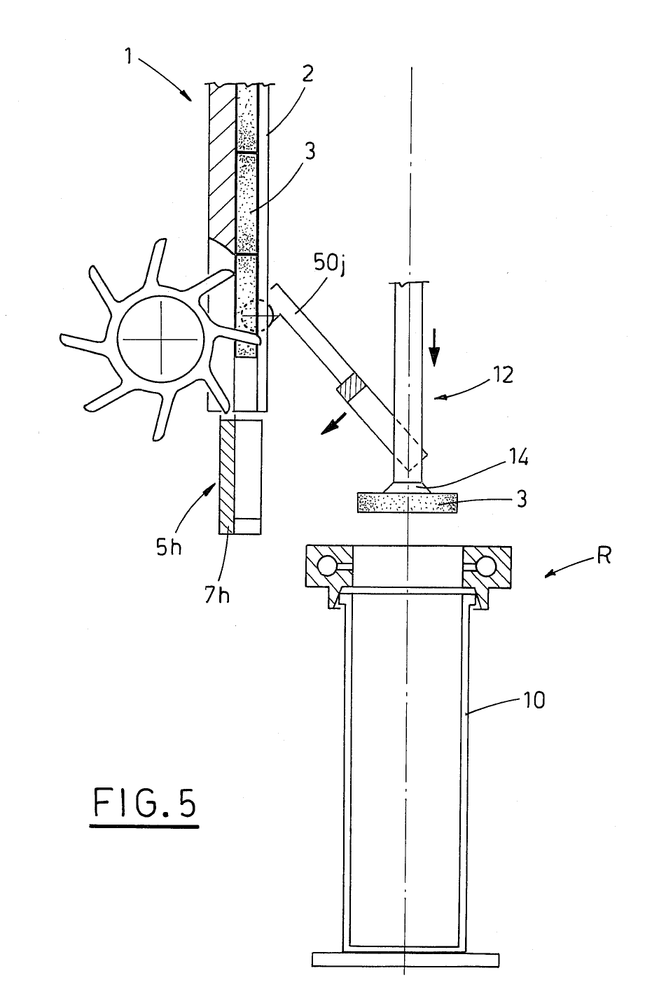

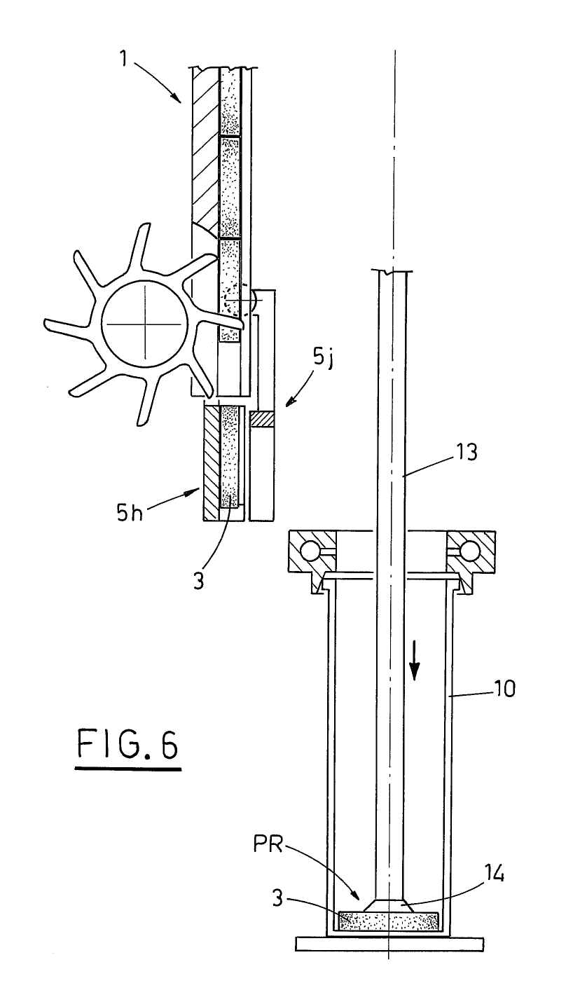

The first element 5h (lower element) then returns towards the loading region (FIG. 4) and the aspiration units 12 move vertically, retaining the corresponding pills 3, towards the relative release position PR (the height of which depends time by time on the filling level of the tubes 10) in the station R, to fill the tubes 10 (FIG. 6). Following the movement of the aspiration units 12 towards the release position PR, the second element 5j is returned to the loading region C, concluding an operating cycle, so that it does not interfere with the gripping action on the pills 3 performed by the aspirating units 12.

Each seating 6 advantageously exhibits a lower opening 15 identified by the interspace between the adjacent shaped supports 8h. This enables discharging of the powder produced by the pills 3, released by the supply units 1 and/or being generated following insertion of the pills 3 internally of the seatings 6.

A further advantage of the invention consists in having defined an apparatus the costs of which are relatively contained with respect to the advantages obtained.

Alternatively to the lateral openings 9j afforded in the second element 5j, corresponding through-holes of a suitable diameter can be afforded; in this case the return of the second element 5j into the loading region C can be done only when the aspiration unit 12 has returned into the removal position P, following the release of the pills 3 into the tubes 10.

The suckers 14 are adapted to the shape of the pills 3, in order to optimize the gripping action thereon.

In general the gripping organs 11 can be of any shape and type, even different from the shape illustrated herein, and the angle that the elements 5h, 5j rotate through can be different from ninety degrees.

The foregoing description is provided by way of non-limiting example, and any variations of a practical-applicational nature can be made thereto without its forsaking the ambit of protection as described above and as claimed herein below.

What is claimed is:

1. An apparatus for filling tubes with piles of disc-shaped articles, such as pills, the articles (3) being released intermittently one after another and in a substantially vertical orientation by at least a supply unit (1), characterized in that it comprises: two functional elements (5h, 5j), hinged at a horizontal axis (K) thereof and made to oscillate, in phase relation with a release of the articles (3) from the supply unit (1), between a loading region (C), in which the functional elements (5h, 5j) are near to an outlet section (SU) of the at least a supply unit (1) and are mutually arranged such as to provide at least a corresponding seating (6) for receiving and retaining a relative article (3) released by the supply unit (1) and a disengagement region (D) of the article (3), at which the functional elements (5h, 5j) are rotated by a predetermined angle with respect to the horizontal hinge axis (K), in order to enable a gripping of the article (3) by gripping organs (11); the gripping organs (11) being mobile in a predetermined operating direction in order to remove the article (3) borne by the functional elements (5h, 5j) into the relative disengagement region (D), and to release the article (3) internally of a corresponding tube (10) in phase relation with the movement of the functional elements (5h, 5j).

2. The apparatus of claim 1, characterized in that the angle by which the functional elements (5h, 5j) are rotated between the loading region (C) and the disengagement region (D) is a ninety-degree angle and in that the gripping organs (11) comprise sucker means (14) functionally connected to a source kept in depression, which gripping organs (11) are mobile in the operating direction in a vertical direction between a removal position P of a article (3) reaching the disengagement region (D) and a release position (PR) of the article (3) internally of a corresponding tube (10) in phase relation with the movement of the functional elements (5h, 5j) between the disengagement region (D) and the loading region (C).

3. The apparatus of claim 1, characterized in that the functional elements (5h, 5j) comprise a first and a second shaped element (5h, 5j), respectively borne by at least an activating arm (50h, 50j), hinged to the horizontal axis (K), the first shaped element (5h) having a shape such as to identify at least the seating (6) for receiving the corresponding article (3) released by the at least a supply unit (1) and the second shaped element (5j) comprising at least an abutment portion for ensuring retention of the article (3) in the relative seating (6) when the shaped elements (5h, 5j) are in the loading region (C) and during the movement of the shaped elements (5h, 5j) towards the disengagement region (D).

4. The apparatus of claim 3, characterized in that the second shaped element (5j) further affords at least a through-hole (9j) made in a perpendicular direction to a development surface of the second shaped element (5j), for enabling a gripping action by the gripping organs (11) on the article (3) arriving in the disengagement region (D).

5. The apparatus of claim 4, characterized in that the through-hole (9j) is laterally open towards an outside, thus identifying a lateral opening (9j) for free transit of the gripping organs (11).

6. The apparatus of claim 5, characterized in that the gripping organs (11) comprise a shank (13) freely transiting through the lateral opening (9j) in the operating configurations.

7. The apparatus of claim 3, characterized in that the first shaped element (5h) comprises a lateral wall (7h) and at least two shaped supports (8h) fixed thereto, one by a side of another, the at least a seating (6) being identified by respective facing portions of the shaped supports (8h) and by a corresponding portion of the lateral wall (7h) delimited by the portions of the shaped supports (8h).

8. The apparatus of claim 7, characterized in that the respective facing portions of the shaped supports (8h) substantially have a shape which complements a lower profile of a relative article (3) destined to be stably received in the seating (6).

9. The apparatus of claim 2, characterized in that the functional elements (5h, 5j) comprise a first and a second shaped element (5h, 5j), respectively borne by at least an activating arm (50h, 50j), hinged to the horizontal axis (K), the first shaped element (5h) having a shape such as to identify at least the seating (6) for receiving the corresponding article (3) released by the at least a supply unit (1) and the second shaped element (5j) comprising at least an abutment portion for ensuring retention of the article (3) in the relative seating (6) when the shaped elements (5h, 5j) are in the loading region (C) and during the movement of the shaped elements (5h, 5j) towards the disengagement region (D).

10. The apparatus of claim 9, characterized in that the second shaped element (5j) further affords at least a through-hole (9j) made in a perpendicular direction to a development surface of the second shaped element (5j), for enabling a gripping action by the gripping organs (11) on the article (3) arriving in the disengagement region (D).

11. The apparatus of claim 10, characterized in that the through-hole (9j) is laterally open towards an outside, thus identifying a lateral opening (9j) for free transit of the gripping organs (11).

12. The apparatus of claim 11, characterized in that the gripping organs (11) comprise a shank (13) freely transiting through the lateral opening (9j) in the operating configurations.

13. The apparatus of claim 9, characterized in that the first shaped element (5h) comprises a lateral wall (7h) and at least two shaped supports (8h) fixed thereto, one by a side of another, the at least a seating (6) being identified by respective facing portions of the shaped supports (8h) and by a corresponding portion of the lateral wall (7h) delimited by the portions of the shaped supports (8h).

14. The apparatus of claim 13, characterized in that the respective facing portions of the shaped supports (8h) substantially have a shape which complements a lower profile of a relative article (3) destined to be stably received in the seating (6).
